(19) United States
(12) Patent Application Publication
(10) Pub. No.: US 2016/0303651 A1
(43) Pub. Date: Oct. 20, 2016

(54) Magnet Manufacturing Method And Magnet

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/094,706

(22) Filed: Apr. 8, 2016

(30) Foreign Application Priority Data
Apr. 16, 2015 (JP) 2015-084009

(51) Int. Cl. B22F 1/00; H01F 41/02; H01F 1/053

(52) U.S. Cl. CPC B22F 1/0014; H01F 1/053; H01F 41/0266; B22F 1/0059

(57) ABSTRACT

A magnet manufacturing method has a step of preparing magnetic powder of a hard magnetic material, which includes one or more of an Fe-N-based compound and an R-Fe-N-based compound, a step of pressurizing and molding the magnetic powder at a pressure equal to or higher than a fracture pressure at which the particles of the magnetic powder are destroyed, to obtain a primary molding, and a step of heating the primary molding at a temperature lower than a decomposition temperature of the magnetic powder. The magnetic powder has at least two peaks in a particle size distribution.

### INCORPORATION BY REFERENCE

The disclosure of Japanese Patent Application No. 2015-084009 filed on Apr. 16, 2015 including the specification, drawings and abstract, is incorporated herein by reference in its entirety.

### BACKGROUND OF THE INVENTION

1. Field of the Invention

The invention relates to a magnet manufacturing method and a magnet.

2. Description of Related Art

Japanese Patent Application Publication No. 2007-39794 (JP 2007-39794 A) describes a magnet containing an Nd-Fe-B alloy or an Sm-Fe-N alloy. JP 2007-39794 further discloses that a soft magnetic metal is mixed with the above-described alloy and that the mixture is molded under pressure and sintered.

Japanese Patent Application Publication No. 2012-69962 (JP 2012-69962 A) discloses that an R-Fe-N-H-based magnetic material and soft magnetic powder are mixed together and that the mixture is compacted and solidified by impact compression using an underwater shock wave and that after the impact compression, a residual temperature is kept equal to or lower than a decomposition temperature of the magnetic material. This magnet contains no binder such as resin.

Japanese Patent Application Publication No. 2005-223263 (JP 2005-223263 A) discloses that a rare-earth permanent magnet is manufactured by forming an oxide film on Sm-Fe-N-based compound powder, then preliminarily compression-molding the Sm-Fe-N-based compound powder into a predetermined shape in a non-oxidizing atmosphere, and compacting the resultant compound at 350 to 500° C. in the non-oxidizing atmosphere. JP 2005-223263 discloses that the Sm-Fe-N-based magnet can thus be manufactured at a temperature lower than the decomposition temperature.

Japanese Patent Application Publication No. S62-206801 (JP S62-206801 A) discloses that a stearic acid is mixed with alloy powder to cover powder particles with the stearic acid and that the powder particles are then compression-molded and then sintered.

Japanese Patent Application Publication No. 2015-8200 (JP 2015-8200 A) discloses that a magnet is manufactured by executing a pressurizing step of forming a primary molding by pressurizing magnetic powder of a hard magnetic material a plurality of times using a mold, the magnetic powder being formed using an R-Fe-N-based compound containing a rare earth element as R or an Fe-N-based compound, and then forming a secondary molding by heating the magnetic powder at a temperature lower than the decomposition temperature of the magnetic powder to join surfaces of adjacent magnetic particles.

In JP 2007-39794 A and JP S62-206801 A, dysprosium (Dy), which is expensive and rare, needs to be used for the magnet containing the Nd-Fe-B alloy. When the Sm-Fe-N alloy is used, sintering is difficult due to the low decomposition temperature of the Sm-Fe-N alloy. The sintering involves temperatures equal to or higher than the decomposition temperature, leading to decomposition of the alloy to preclude the resultant magnet from demonstrating its performance as a magnet. Thus, Sm-Fe-N-based magnets are typically joined together with a bond such as resin. However, the use of the bond such as resin reduces the density of the magnet, causing a reduction in residual magnetic flux density.

In JP 2012-69962 A and JP 2005-223263 A, the magnetic particles are not sintered, and thus, gaps remain between particles of the powder in the molded magnet. In other words, the molded magnet of unsintered magnetic powder has lower density than the molded magnet of sintered magnetic powder. As a result, the molded magnet of the unsintered magnetic powder has lower residual magnetic flux density than that of the sintered magnetic powder.

In JP 2015-8200 A, which describes a technique dealing with the above-described problem, when the primary molding has a complicated shape, a high pressurizing pressure cannot be applied depending on the configuration of the mold. In other words, an increase in density is limited depending on the shape of the molding. Then, enhancement of the residual magnetic flux density of the manufactured magnet is also limited.

### SUMMARY OF THE INVENTION

An object of the invention is to provide a magnet manufacturing method and a magnet that allow a high residual magnetic flux density to be obtained without the use of a bond.

A magnet manufacturing method according to an aspect of the invention includes preparing magnetic powder of a hard magnetic material, which includes one or more of an Fe-N-based compound and an R-Fe-N-based compound (R: rare earth element),
pressurizing and molding the magnetic powder at a pressure equal to or lower than a fracture pressure at which particles of the magnetic powder are destroyed in order to obtain a primary molding, and
heating the primary molding at a temperature lower than a decomposition temperature of the magnetic powder. The magnetic powder has at least two peaks in a particle size distribution.

In the magnet manufacturing method, a compound that includes one or more of the Fe-N-based compound and the R-Fe-N-based compound is used as the magnetic powder of the hard magnetic material. Thus, a magnet can be inexpensively manufactured.

In the preparation of the magnetic powder of the hard magnetic material, the magnetic powder prepared exhibits at least two peaks when the particle size distribution is measured. In the subsequent pressurization performed to obtain a primary molding, the magnetic powder is pressurized at the pressure equal to or lower than the fracture pressure to allow particles of the magnetic powder that have small particle sizes to be fitted between gaps defined between particles of the magnetic powder that have large particle sizes. Thus, a dense primary molding with reduced gaps is obtained. The primary molding is heated to join surfaces of the particles of the magnetic powder together to form a secondary molding. The secondary molding is configured such that the magnetic powder particles are joined together in the dense primary molding with the filled gaps.
As described above, the manufacturing method according to this aspect allows manufacture of a dense magnet with filled gaps.

The manufacturing method according to this aspect further allows a dense magnet with filled gaps to be manufactured in manufacture of a magnet that has a complicated shape and that makes an increase in molding pressure difficult. The manufacturing method in this aspect is particularly effective in manufacturing a magnet with a complicated shape.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating steps of a magnet manufacturing method according to a first embodiment;

FIG. 2 is a diagram of a measurement result for a particle size distribution of magnetic powder in the first embodiment;

FIG. 3 is a diagram of a measurement result for a particle size distribution of fine powder of the magnetic powder in the first embodiment;

FIG. 4 is a diagram of a measurement result for a particle size distribution of coarse powder of the magnetic powder in the first embodiment;

FIG. 5 is a graph illustrating a relationship between the density of a primary molding and a mixture ratio of the fine powder to the coarse powder in the magnetic powder in the first embodiment;

FIG. 6 is a schematic diagram illustrating a mixing step for the magnetic powder and a lubricant in the first embodiment;

FIG. 7 is a schematic diagram illustrating the mixing step for the magnetic powder and a lubricant in the first embodiment;

FIG. 8 is a schematic diagram illustrating a pressurizing step for the magnetic powder and a lubricant in the first embodiment;

FIG. 9 is a schematic diagram illustrating the pressurizing step for the magnetic powder and a lubricant in the first embodiment;

FIG. 10 is an enlarged view schematically depicting a configuration of the primary molding in the first embodiment; and

FIG. 11 is a diagram illustrating changes in a heating temperature for a heat treatment step in the first embodiment.

### DETAILED DESCRIPTION OF EMBODIMENTS

A magnet manufacturing method according to the invention will be described as an embodiment with reference to FIGS. 1 to 11. FIG. 1 is a diagram illustrating steps of the magnet manufacturing method of a first embodiment.

As illustrated in step S1 in FIG. 1, magnetic powder 1 of a hard magnetic material as a raw material for a magnet is prepared.

As the magnetic powder 1, a compound is used which includes one or more of an Fe-N-based compound and an R-Fe-N-based compound. A rare earth element represented by R is preferably an element that is known as a so-called rare earth element and that is other than Dy. In particular, light rare earth elements are preferable, and among the light rare earth elements, Sm is suitable. The light rare earth elements described herein refer to elements included in lanthanoids and each having a smaller atomic weight than Gd, that is, La, Ce, Pr, Nd, Pm, Sm, and Eu. A specific composition of the magnetic powder 1 is not limited as long as the magnetic powder 1 is an Fe-N-based compound or an R-Fe-N-based compound. Powder of Sm₂Fe₁₇N₃ or Fe₁₆N₂ is suitably used.

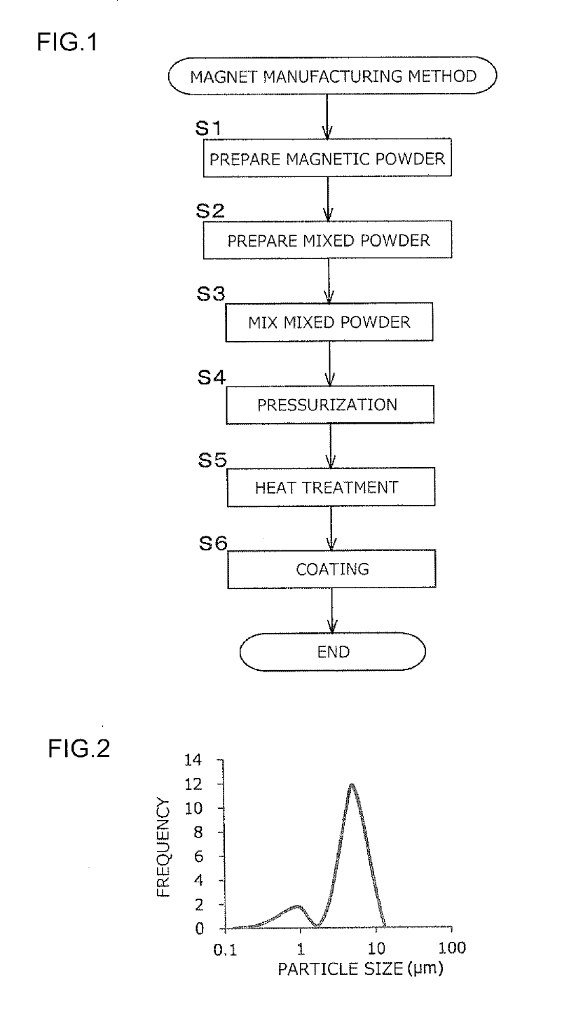

The magnetic powder 1 prepared exhibits two peaks (a plurality of peaks) as depicted in FIG. 2 when a particle size distribution is measured. A measurement method for the particle size distribution is not limited. Any measurement method (calculation method) may be used which allows particle size and frequency to be understood.

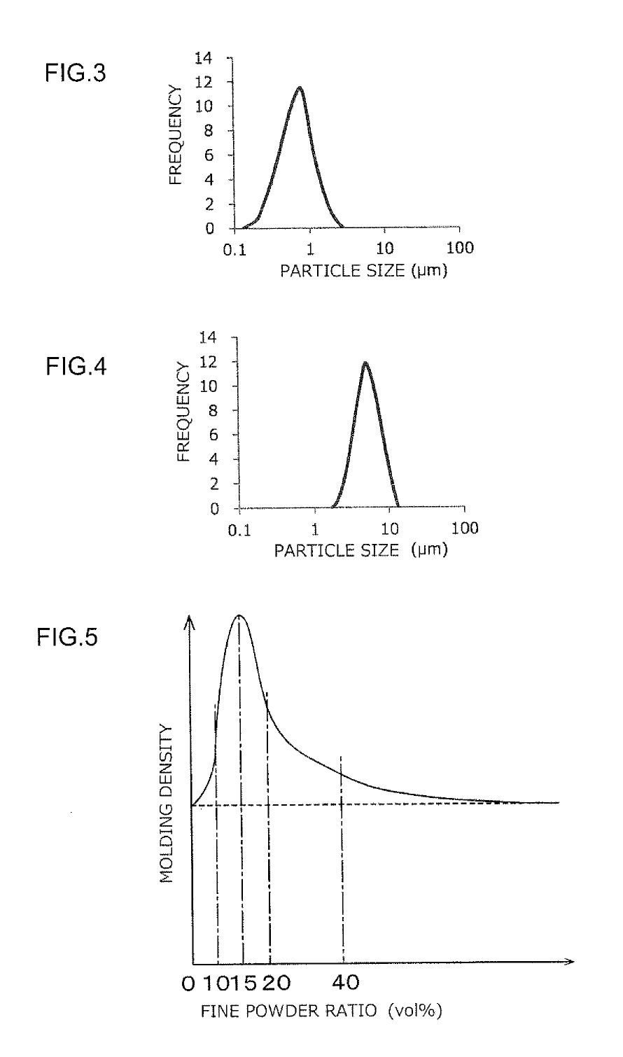

The particle size distribution of the magnetic powder 1 in the present embodiment illustrated in FIG. 2 has two peaks at particle sizes of 0.75 μm and 4 μm. A manufacturing method for the magnetic powder 1 in the present embodiment is not limited as long as the magnetic powder 1 has the particle size distribution depicted in FIG. 2. For example, the magnetic powder 1 is obtained by mixing fine powder 11 that exhibits a particle size distribution depicted in FIG. 3 and that has an average particle size (D50) of 0.75 μm with coarse powder 12 that exhibits a particle size distribution depicted in FIG. 4 and that has an average particle size (D50) of 4 μm. As depicted in FIG. 3 and FIG. 4, the fine powder 11 and the coarse powder 12 each have sharp peaks in the particle size distribution. The particle size distribution peaks of the fine powder 11 and the coarse powder 12 do not substantially overlap.

When the magnetic powder 1 in the present embodiment is mixed powder of the fine powder 11 and the coarse powder 12, the ratio of the particle size of fine powder 11 to the particle size of the coarse powder 12 preferably falls within a range from 1:4 to 1:7. When the ratio of the particle sizes is within this range, particles of the fine powder 11 are densely placed in gaps between particles of the coarse powder 12. When the ratio of the particle sizes is lower than 1:4, each of the particles of the fine powder 11 is excessively small compared to the corresponding gap between the particles of the coarse powder 12. Thus, gaps remain between the particles of the coarse powder 12. When the ratio of the particle sizes is higher than 1:7, each of the particles of the fine powder 11 is larger than the corresponding gap between the particles of the coarse powder 12. The fine powder 11 hinders the particles of the coarse powder 12 from being proximate to one another. In other words, the gaps between the particles of the coarse powder 12 are enlarged.

When the magnetic powder 1 in the present embodiment is mixed powder of the fine powder 11 and the coarse powder 12, the volume ratio of the fine powder 11 to the coarse powder 12 preferably falls within a range from 10:90 to 40:60. A volume ratio within this range allows the particles of the fine powder 11 to be densely placed in the gaps between the particles of the coarse powder 12. A volume ratio of less than 10:90 leads to few particles of the fine powder 11 with respect to the gaps between the particles of the coarse powder 12. Thus, gaps remain between the particles of the coarse powder 12. A volume ratio of more than 40:60 leads to many particles of the fine powder 11 with respect to the gaps between the particles of the coarse powder 12. Thus, the fine powder 11 is placed between the particles of the coarse powder 12. As a result, the particles of the fine powder 11 hinder the particles of the coarse powder 12 from being proximate to one another. In other words, the gaps between the particles of the coarse powder 12 are enlarged.

FIG. 5 illustrates a relationship between the mixture ratio (volume ratio) of the fine powder 11 to the coarse powder 12 in the magnetic powder 1 in FIG. 2 and the density of a primary molding obtained in a pressurizing step described below (step S4) in the present embodiment.

FIG. 5 indicates that a dense primary molding is obtained by setting the volume ratio of the fine powder 11 to the coarse powder 12 to 10:90 to 40:60. As depicted in FIG. 5, the volume ratio of the fine powder 11 to the coarse powder is more preferably 10:90 to 20:80. The magnetic powder in the present embodiment is obtained by mixing the fine powder 11 and the coarse powder 12 such that the volume ratio of the fine powder 11 to the coarse powder 12 is 15:85. This ratio is most preferable.
The magnetic powder 1 in the present embodiment is formed by mixing a plurality of types of powder with the same compositions (fine powder 11 and coarse powder 12) but may be formed by mixing a plurality of types of powder with different compositions.

The magnetic powder 1 prepared in the present embodiment preferably contains an even mixture of the fine powder 11 and the coarse powder 12. That is, the magnetic powder 1 is preferably obtained by mixing and stirring the fine powder 11 and the coarse powder 12. The mixture of the fine powder 11 and the coarse powder 12 may be performed in step S3 described below in conjunction with mixing and stirring of a lubricant and the magnetic powder 1.

In the magnetic powder 1 in the present embodiment, the particle size (average particle size: D50) of the particles of the coarse powder 12 is preferably approximately 2 μm to 5 μm and more preferably approximately 3 μm to 4 μm. The particle size (average particle size: D50) of the particles of the fine powder 11 is preferably approximately 0.29 μm to 1.25 μm and more preferably approximately 0.43 μm to 1.00 μm.

As illustrated in step S2 in FIG. 1, the magnetic powder 1 prepared in step S1 and a lubricant 2 (solid lubricant powder) that is powdery at normal temperature are prepared.

Metal soap powder is used as the lubricant 2. As the lubricant 2, powder of stearic acid-based metal such as zinc stearate is used. The particle size of the lubricant 2 is not limited but may be approximately 10 μm. In other words, the lubricant 2 has a larger average particle size than the coarse powder 12 in the magnetic powder 1. The lubricant 2 has a smaller specific gravity than the magnetic powder 1. Setting a somewhat large initial size for the lubricant 2 enables each particle of the lubricant 2 to have a large mass. This prevents the lubricant 2 from being stirred up in step S3 described below when the lubricant 2 is mixed with the magnetic powder 1.

As illustrated in step S3 in FIG. 1, the magnetic powder 1 and the lubricant 2 prepared in the step S2 are mixed together while being ground.

A mixture ratio between the magnetic powder 1 and the lubricant 2 can be optionally set. The preferable mixture ratio between the magnetic powder 1 and the lubricant 2 is such that, in volume percentage, the magnetic powder is 80 to 90 vol %, whereas the lubricant 2 is 5 to 15 vol %. Besides the magnetic powder 1 and the lubricant 2, an additive may be added. Examples of the additive include organic solvents that disappear as a result of subsequent heating.

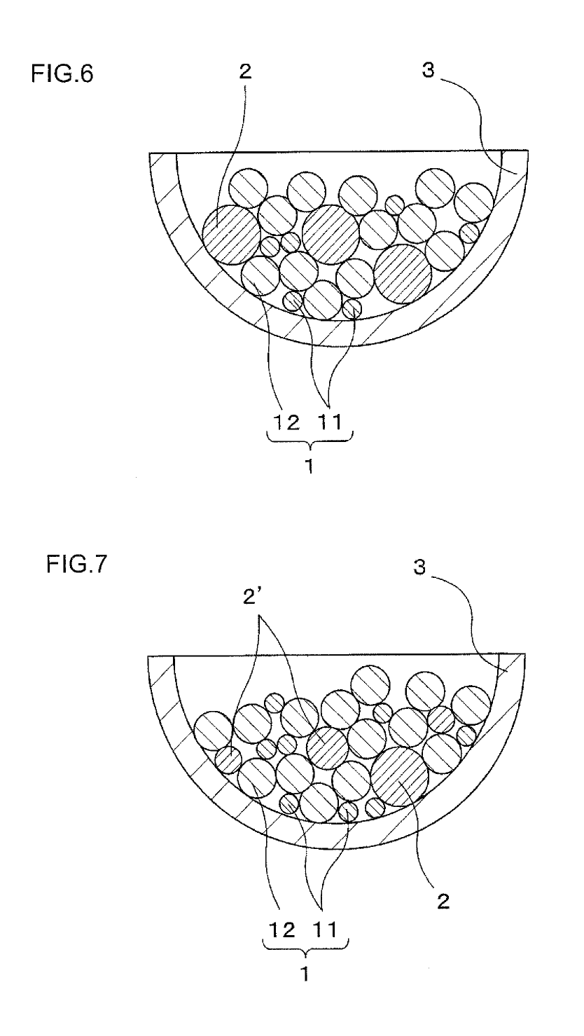

Any method may be used to mix the magnetic powder 1 and the lubricant 2 together as long as the method allows the magnetic powder 1 and the lubricant 2 to be mixed together while being ground. For example, in a mixture container 3, the magnetic powder 1 (fine powder 11 and coarse powder 12) and the lubricant 2 are mixed together while being ground as depicted in a schematic diagram in FIG. 6. Mixing and simultaneously grinding the magnetic powder 1 and the lubricant 2 fractionizes the lubricant 2, which has a low binding strength, to reduce the general particle size of the lubricant 2, as depicted in a schematic diagram in FIG. 7. Thus, particles of the lubricant 2 present at the end of the mixing step have different particle sizes.
During the mixture of the magnetic powder 1 and the lubricant 2, grinding is performed at a pressure at which the magnetic powder 1 is prevented from being destroyed.

At the end of the mixing step, the mixed powder of the magnetic powder 1 and the lubricant 2 can contain reduced massive portions formed only of the magnetic powder 1 and have a reduced particle size of the lubricant 2. In other words, fine particles 2 and 2′ of the lubricant resulting from crushing can be present at positions proximate to each particle of the magnetic powder 1.

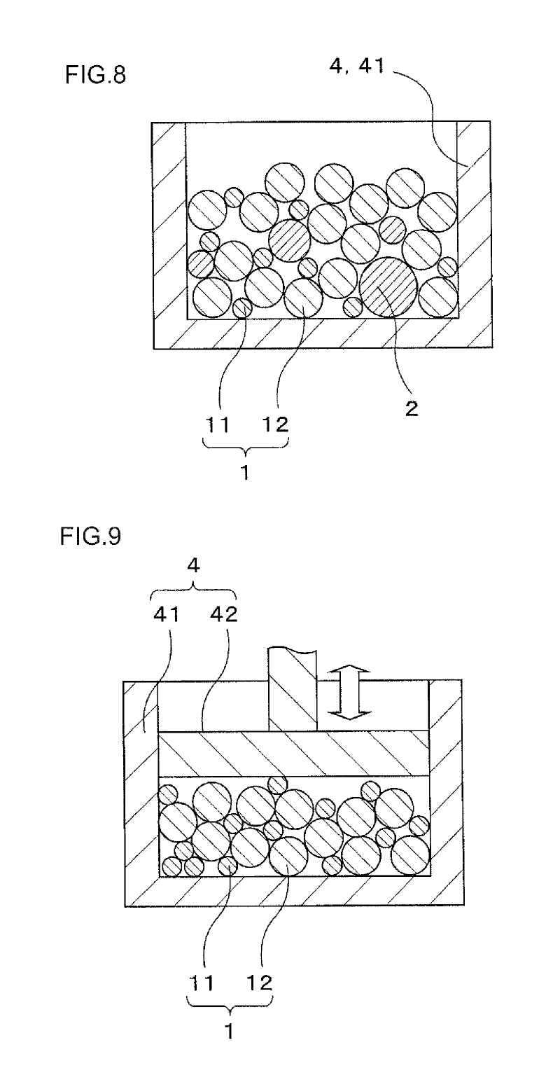

Subsequently, as illustrated in step S4 in FIG. 1, the mixed powder of the magnetic powder 1 and the lubricant 2 is pressurized to form a primary molding 5 (FIGS. 8 and 9).

In the pressurizing step, as depicted in a schematic diagram in FIG. 8, the mixed powder of the magnetic powder 1 and the lubricant 2 is fed into a cavity in a pressurizing mold 4 (pressurizing lower mold 41 (mold)).

As depicted in a schematic diagram in FIG. 9, a pressurizing upper mold 42 (mold) is assembled into the pressurizing lower mold 41 and moved in a direction in which the pressurizing upper mold 42 approaches the pressurizing lower mold 41. Thus, the mixed powder is molded under pressure using the pressurizing mold 4 (41 and 42). At this time, a pressure applied by the pressurizing mold 4 (41 and 42) is a pressure equal to or lower than a fracture pressure at which the magnetic powder 1 in the mixed powder of the magnetic powder 1 and the lubricant 2 is destroyed. In the present embodiment, the applied pressure is equal to or lower than 1 GPa.

Pressurization with the pressurizing mold 4 (41 and 42) is performed a plurality of times. In other words, after a pressure is applied to the pressurizing upper mold 42, the pressure applied to the pressurizing upper mold 42 is weakened, and then, a pressure is applied to the pressurizing upper mold 42 again. Then, this operation is repeated. To weaken the pressure applied to the pressurizing upper mold 42, the pressurizing upper mold 42 may be moved upward or only the applied pressure may be reduced without upward movement of the pressurizing upper mold 42.

Pressurization with the pressurizing mold 4 (41 and 42) is performed a plurality of times, and an upper limit on the number of pressurizations may be the number of pressurizations resulting in saturation of the effect of an increase in the density of the primary molding. For example, the pressurization may be performed twice to thirty times.

In the pressurizing step, the pressurizing mold 4 (41 and 42) is heated at an outer side surface thereof using a heater (not depicted in the drawings) to heat the mixed powder of the magnetic powder 1 and the lubricant 2. A heating temperature T₁ for the mixed powder of the magnetic powder 1 and the lubricant 2 is lower than a decomposition temperature of the magnetic powder 1 and equal to or higher than a melting point T₃ of the lubricant 2 (T₃≦T₁<T₂). Therefore, the magnetic powder 1 is not decomposed even on heating. The lubricant 2, which is solid (powdery) at normal temperature, becomes a liquid during the pressurizing step because the lubricant 2 is heated at the melting point thereof or higher.

In this manner, while the magnetic powder 1, contained in the mixed powder of the magnetic powder 1 and the lubricant 2, is being pressurized, the lubricant 2 becomes a liquid instead of a solid and has a viscosity corresponding to the temperature. The viscosity of the lubricant 2 decreases with an increase in the heating temperature T₁. The liquid lubricant 2 adheres to the entire surface of each of the particles of the magnetic powder 1 without being segregated.

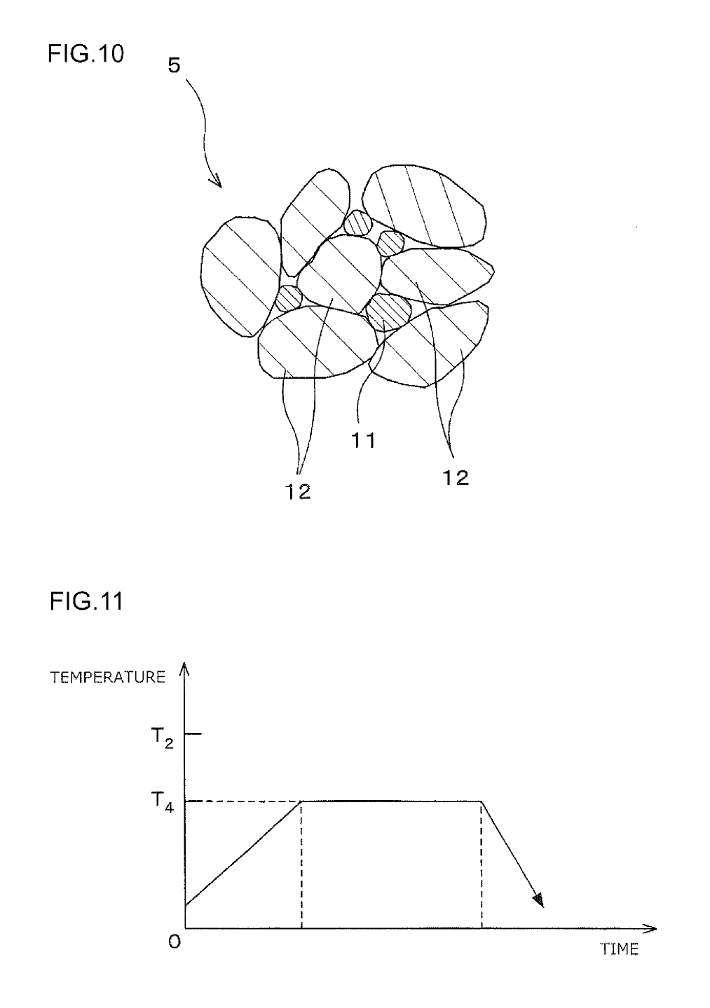

As depicted in an enlarged view in FIG. 10, repeated pressurizations allow an increasing number of particles of the fine powder 11 to be placed between the particles of the coarse powder 12. Thus, a primary molding 5 is formed with reduced gaps between the particles of the magnetic powder 1. This is because a plurality of pressurizations allows rearrangement of the particles of the magnetic powder 1 arranged as a result of the last pressurization.

In the pressurizing mold 4, the liquid lubricant 2 is interposed between the adjacent particles of the magnetic powder 1 to allow the particles of the magnetic powder 1 to move smoothly. The gaps between the particles of the magnetic powder 1 in the primary molding 5 are reduced by synergetic action of rearrangement of the particles of the magnetic powder 1 and sliding of the particles of the magnetic powder 1 due to the lubricant 2.

As illustrated in step S5 in FIG. 1, the primary molding 5 is heated in an oxidizing atmosphere to form a secondary molding (heat treatment step).

Heating the primary molding 5 in the oxidizing atmosphere causes exposed surfaces of the particles of the magnetic powder 1 to react with oxygen to generate an oxide film on the surface of each of the particles of the magnetic powder 1. The oxide film joins the surfaces of the adjacent particles of the magnetic powder 1. The oxide film is formed on a portion of each particle of the magnetic powder 1, which is exposed to the gap, while a base material with no oxide film formed thereon constitutes a portion of each particle of the magnetic powder 1, which is not exposed to the gap (the interface at which the particle of the magnetic powder 1 is compressed against the adjacent particle of the magnetic powder 1). Therefore, the oxide film is not formed all over the surface of each particle of the magnetic powder 1.

The secondary molding thus formed has a sufficient strength. This enables an increase in a flexural strength of the secondary molding. Moreover, in the pressurizing step, areas of the primary molding 5 where no magnetic powder 1 is present are reduced, enabling an increase in residual magnetic flux density of the secondary molding resulting from the heat treatment step. The secondary molding has a density of approximately 5 to 6 g/cm³.

The heat treatment step is executed with the primary molding 5 placed in a microwave heating furnace, an electric furnace, a plasma heating furnace, a high-frequency quenching furnace, a heating furnace with an infrared heater, or the like. The heating during the heat treatment step is not limited but may be performed so as to go through temperature changes depicted in FIG. 11.

As depicted in FIG. 11, a heating temperature T₄ is set lower than the decomposition temperature T₂ of the magnetic powder 1. For example, when Sm₂Fe₁₇N₃ or Fe₁₆N₂ is used as the magnetic powder 1, the heating temperature T₄ is set lower than 500° C. because the decomposition temperature T₂ of Sm₂Fe₁₇N₃ or Fe₁₆N₂ is approximately 500° C. For example, the heating temperature T₄ in the heat treatment step is approximately 200 to 300° C.

An oxygen concentration and an atmospheric pressure in the oxidizing atmosphere may be set to any values as long as the oxygen concentration and the atmospheric pressure allow the magnetic powder 1 to be oxidized. An oxygen concentration and an atmospheric pressure equal or close to the oxygen concentration and the atmospheric pressure in the air are sufficient for this purpose. Therefore, special management of the oxygen concentration and the atmospheric pressure is not needed. The heating may be performed in the aerial atmosphere. Setting the heating temperature T₄ at approximately 200 to 300° C. allows an oxide film to be formed regardless of whether the magnetic powder is Sm₂Fe₁₇N₃ or Fe₁₆N₂.
As illustrated in step S6 in FIG. 1, a treatment is executed in which the surface of the secondary molding formed in the heat treatment step is covered with a coating film, to form a tertiary molding.

Examples of the coating film for the tertiary molding include a plating film formed by electroplating of Cr, Zn, Ni, Ag, Cu, or the like, a plating film formed by electroless plating, a resin film formed by resin coating, a glass film formed by glass coating, and a film formed of Ti, diamond-like carbon (DLC), or the like. Examples of the electroless plating include electroless plating using Ni, Au, Ag, Cu, Sn, Co, or an alloy or a mixture thereof Examples of the resin coating include coating with a silicone resin, a fluorine resin, a urethane resin, or the like.

The coating film formed on the tertiary molding functions like an egg shell. The tertiary molding can have an increased flexural strength as a result of a joining force exerted by the oxide film and the coating film. In particular, the electroless plating enables surface hardness and adhesion to be enhanced and allows the joining force of the magnetic powder 1 to be made stronger. Furthermore, for example, electroless nickel-phosphorous plating offers high corrosion resistance.

As described above, the oxide film joins the particles of the magnetic powder 1 together not only on the surface of the secondary molding but also inside the secondary molding. The joining force of the oxide film regulates free movement of the particles of the magnetic powder 1 inside the tertiary molding. This suppresses inversion of magnetic poles resulting from rotation of the magnetic powder 1. A high residual magnetic flux density can be achieved.

When the electroplating is applied in the coating step, the unplated secondary molding acts as an electrode. Thus, the secondary molding needs to have a high joining strength. However, when the electroless plating, the resin coating, or the glass coating is applied in the coating step, the joining strength of the secondary molding need not be so high as the joining strength needed for the secondary molding when the electroplating is applied. The joining force resulting from the oxide film is sufficient. Therefore, the coating step as described above allows the coating film to be reliably formed on the surface of the secondary molding.

When the electroless plating is applied in the coating step, the secondary molding is immersed in a plating solution. At this time, the plating solution acts to enter the inside of the secondary molding. However, the oxide film formed on the secondary molding effectively suppresses the entry of the plating solution. This is expected to inhibit possible corrosion of the secondary molding or the like resulting from the entry of the plating solution into the inside of the secondary molding.

In the manufacturing method of the present embodiment, a compound that includes one or more of an Fe-N-based compound and an R-Fe-N-based compound (R: rare earth element) is used as the magnetic powder 1 of the hard magnetic material. Thus, a magnet can be inexpensively manufactured.
Furthermore, the manufacturing method in the present embodiment allows avoidance of the use of dysprosium (Dy) as R. Therefore, a magnet can be inexpensively manufactured.

In the step of preparing the magnetic powder of the hard magnetic material (step 1) in the manufacturing method in the present embodiment, the magnetic powder prepared exhibits at least two peaks when the particle size distribution is measured. In the subsequent pressurizing step of obtaining the primary molding 5 (step S4), the magnetic powder 1 is pressurized at the pressure equal to or lower than the fracture pressure so that the particles of the magnetic powder 1 that have small particle sizes (fine powder 11) are fitted between the gaps defined between the particles of the magnetic powder 1 that have large particle sizes (coarse powder 12). Thus, the dense primary molding 5 with reduced gaps is obtained. The primary molding 5 is heated (subjected to heat treatment) to join the surfaces of particles of the magnetic powder 1 together to form a secondary molding. The secondary molding is configured such that the magnetic powder particles are joined together in the dense primary molding 5 with the filled gaps.
As described above, the manufacturing method according to the present embodiment allows manufacture of a dense magnet with filled gaps.

The manufacturing method according to the present embodiment allows a magnet with a high residual magnetic flux density to be obtained without the use of dysprosium (Dy) or a bond. In the manufacturing method according to the present embodiment, since a magnet with a high residual magnetic flux density can be obtained, a magnet can be acquired which has high magnetic characteristics in spite of its complicated shape.

In the manufacturing method according to the present embodiment, the magnetic powder 1 is prepared which is a mixture of two or more types of magnetic powder (fine powder 11 and coarse powder 12) with different average particle sizes (D50). Thus, the magnetic powder 1 is easily obtained which exhibits at least two peaks when the particle size distribution is measured.

In the manufacturing method according to the present embodiment, the pressurization is performed a plurality of times in the pressurizing step (step S4). Performing the pressurization twice or more causes the fine powder 11 to move to the gaps between the particles of the coarse powder 12, leading to the dense primary molding 5 with filled gaps.

In the manufacturing method according to the present embodiment, the solid lubricant powder 2 is mixed with the magnetic powder 1. Consequently, the pressurization in the pressurizing step (step S4) facilitates movement of the fine powder 11 to the gaps between the particles of the coarse powder 12. That is, the dense primary molding 5 with filled gaps is obtained.

In heat treatment step (step S5) of heating the primary molding 5 in the manufacturing method according to the present embodiment, the primary molding 5 is heated at a temperature equal to or higher than the melting point T₃ of the lubricant 2. Consequently, the lubricant 2 is placed on the surface of each of the particles of the magnetic powder 1 forming the primary molding 5.

In the first embodiment described above, as the magnetic powder of the hard magnetic material serving as the raw material of the magnet, magnetic powder is used which exhibits two peaks when the particle size distribution is measured. However, according to a second embodiment magnetic powder with three or more peaks may be used.

Even in this case, magnetic powder can be prepared by mixing a number of types of powder with different average particle sizes together. When the magnetic powder is formed by mixing fine powder, medium powder, and coarse powder together, the magnetic powder exhibits three peaks when the particle size distribution is measured.

Preferably, in the magnetic powder with three peaks, the ratio of the particle size (average particle size: D50) of the fine powder 11 to the particle size (average particle size: D50) of the medium powder falls within a range from 1:5 to 1:7, and the ratio of the particle size (average particle size: D50) of the medium powder to the particle size (average particle size: D50) of the coarse powder 12 falls within a range from 1:5 to 1:7.

Preferably, in the magnetic powder with three peaks, the volume ratio of the fine powder to the medium powder falls within a range from 10:90 to 40:60 and the volume ratio of the medium powder to the coarse powder falls within a range from 10:90 to 40:60.

The present embodiment is configured similarly to the first embodiment except that the magnetic powder is formed by mixing the fine powder, the medium powder, and the coarse powder, and exerts effects similar to the effects of the first embodiment.

In the present embodiment, the medium powder is placed in the gaps between the particles of the coarse powder 12, and the fine powder 11 is placed in the gaps between the particles of the medium powder. That is, a dense primary molding with more appropriately filled gaps is obtained.

In the pressurizing step in the above-described embodiments, the mixed powder of the magnetic powder 1 and the lubricant 2 is heated by heating the pressurizing mold 4. However, the invention is not limited to these embodiments. The mixed powder of the magnetic powder 1 and the lubricant 2 may be heated to the heating temperature T₁ immediately before being placed in the pressurizing mold 4.

In the above-described embodiments, the lubricant 2 used is solid (powdery) at normal temperature. However, a lubricant that is liquid at normal temperature may be used. Even in this case, the liquid lubricant and the magnetic powder 1 may be mixed together in the mixing step. Moreover, the mixed powder is heated in the pressurizing step to reduce the viscosity of the lubricant. Thus, the lubricant spreads all over the surface of the magnetic powder 1. This allows the particles of the magnetic powder 1 to move smoothly, resulting in an increased density of the primary molding 5.

What is claimed is:

1. A magnet manufacturing method comprising:
preparing magnetic powder of a hard magnetic material, which includes one or more of an Fe-N-based compound and an R-Fe-N-based compound;
pressurizing and molding the magnetic powder at a pressure equal to or lower than a fracture pressure at which particles of the magnetic powder are destroyed in order to obtain a primary molding; and
heating the primary molding at a temperature lower than a decomposition temperature of the magnetic powder, wherein
the magnetic powder has at least two peaks in a particle size distribution.

2. The magnet manufacturing method according to claim 1, wherein
the magnetic powder is a mixture of two or more types of magnetic powder with different average particle sizes.

3. The magnet manufacturing method according to claim 1, wherein
the pressurization is performed a plurality of times.

4. The magnet manufacturing method according to claim 1, wherein
solid lubricant powder is mixed with the magnetic powder.

5. The magnet manufacturing method according to claim 4, wherein
in the heating of the primary molding, the primary molding is heated at a temperature equal to or higher than a melting point of the solid lubricant.

6. A magnet manufactured by the magnet manufacturing method according to claim 1.
